(19) United States
(12) Patent Application Publication
(10) Pub. No.: US 2006/0152778 A1
(43) Pub. Date: Jul. 13, 2006

(54) Method of controlling digital image processing apparatus for accurate printing and digital image processing apparatus adopting the method

(75) Inventor: Won-jung Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/109,588

(22) Filed: Apr. 19, 2005

(30) Foreign Application Priority Data
Jan. 11, 2005 (KR) 10-2005-0002447

(51) Int. Cl. H04N 1/46

(52) U.S. Cl. 358/540

(57) ABSTRACT

Provided is a method of controlling a digital image processing apparatus that controls an operation of a printer while communicating with the printer. In the method, a date insertion mode set by the printer is cancelled if the date insertion mode is set by the printer and a date image is synthesized with an image to be printed by the printer.

This application claims the priority of Korean Patent Application No. 10-2005-0002447, filed on Jan. 11, 2005, in the Korean Intellectual Property Office, the disclosure of which is incorporated herein in its entirety by reference.

### BACKGROUND OF THE INVENTION

1. Field of the Invention

The present invention relates to a method of controlling a digital image processing apparatus and a digital image processing apparatus adopting the method. More particularly, the present invention relates to a method of controlling a digital image processing apparatus that controls an operation of a printer while communicating with the printer and a digital image processing apparatus adopting the method.

2. Description of the Related Art

A conventional digital image processing apparatus is disclosed in U.S. Patent Publication No. 119,876 entitled “Method of Notification of Inadequate Picture Quality.” The disclosed conventional digital image processing apparatus controls the operation of a printer while communicating with the printer. In this case, a user can set a date insertion mode in which a date can be inserted into an image printed by the printer. Also, the user can insert a date into an image obtained as a result of a photographing operation.

Since the conventional digital image processing apparatus inserts a date into the printed image again, the quality of the printed image deteriorates.

### SUMMARY OF THE INVENTION

The present invention provides a method of controlling a digital image processing apparatus that can improve the quality of a printed image by preventing double insertion of a date into the printed image and a digital image processing apparatus adopting the method.

According to an embodiment of the present invention, there is provided a method of controlling a digital image processing apparatus that controls an operation of a printer while communicating with the printer. The method includes canceling a date insertion mode set by the printer if the date insertion mode is set by the printer and a date image is synthesized with an image to be printed by the printer.

In the method, the printer does not insert a date into an image synthesized with a date image by the printer. Since a date is not inserted again into a printed image, the quality of the printed image can be improved.

According to another embodiment of the present invention, there is provided a digital image processing apparatus adopting the controlling method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of a digital camera according to the present invention;

FIG. 2 is a perspective view illustrating the back of the digital camera of FIG. 1;

FIG. 3 is a schematic diagram of the configuration of the digital camera of FIG. 1;

FIG. 4 is a flowchart illustrating a main program of a digital camera processor (DSP) illustrated in FIG. 3;

FIG. 5 is a flowchart illustrating an embodiment of the preview mode program of FIG. 4;

FIG. 6 is a flowchart illustrating an embodiment of the photographing mode program of FIG. 4;

FIG. 7 shows the digital camera connected to a printer via a USB cable to illustrate an example of generating a communication standby signal in operation S10 of FIG. 4;

FIG. 8 is a flowchart illustrating a printing mode program performed in a connection condition of FIG. 7 as an example of a communication mode of FIG. 4;

FIGS. 9 through 12 show screens displayed on a color LCD panel as a result of performing operations S802 through S806 of FIG. 8;

FIG. 13 shows a screen displayed on the color LCD panel just before a print command signal is generated in operation S808 of FIG. 8; and

FIG. 14 is a flowchart illustrating a multiple-image output mode program of FIG. 8.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete and will fully convey the concept of the invention to those skilled in the art.

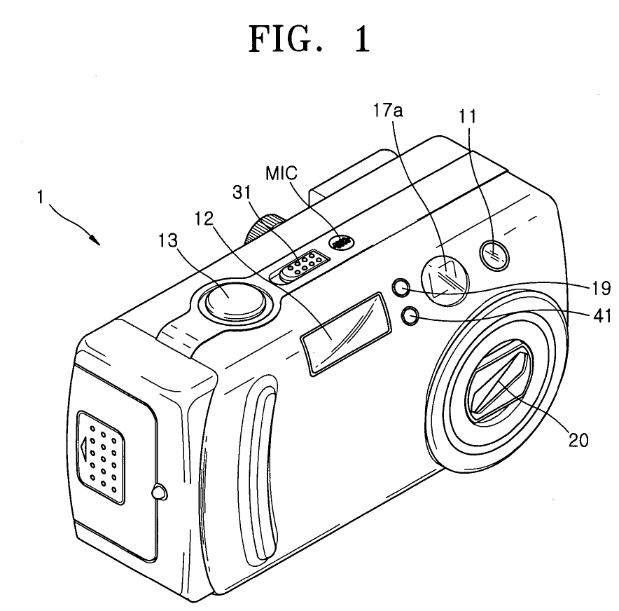

Referring to FIG. 1, the front part of an embodiment of a digital camera 1 according to the present invention includes a self-timer lamp 11, a flash 12, a viewfinder 17a, a flash-luminance sensor 19, a lens unit 20, and a remote receiver 41. The top of the digital camera 1 includes a shutter release button 13, a power switch 31, and a microphone MIC.

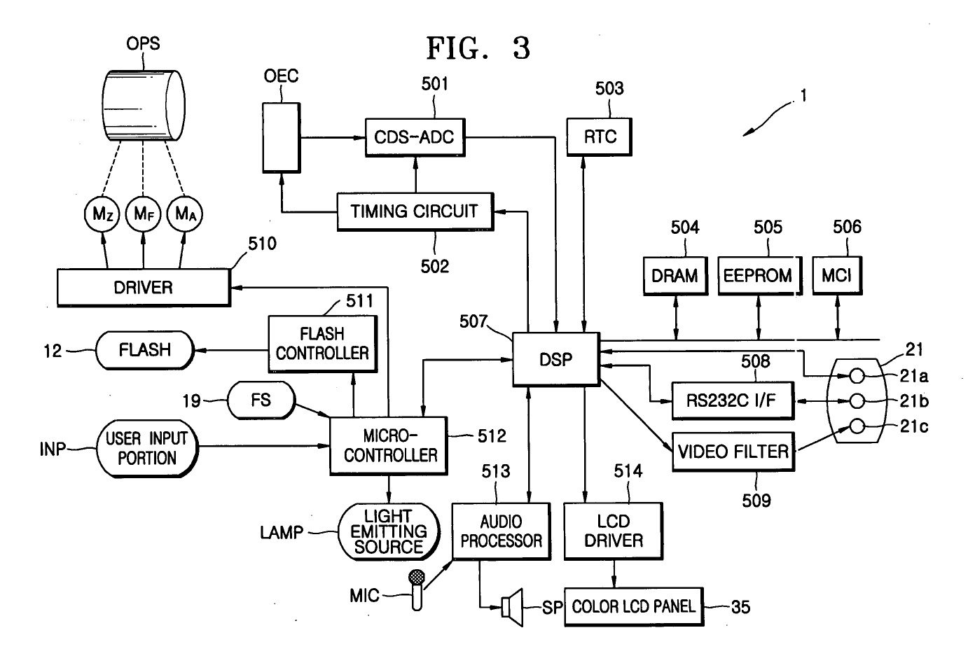

In a self-timer mode, the self-timer lamp 11 operates for a set period of time from the time when the shutter release button 13 is pressed to the time when an image starts to be captured. When the flash 12 operates, the flash-luminance sensor 19 senses luminance and relays the sensed luminance to a digital signal processor (DSP) 507 of FIG. 3 via a micro-controller 512 of FIG. 3. The remote receiver 41 receives command signals, for example, a photographing command signal, from a remote controller (not shown) and relays the photographing command signal to the DSP 507 via the micro-controller 512.

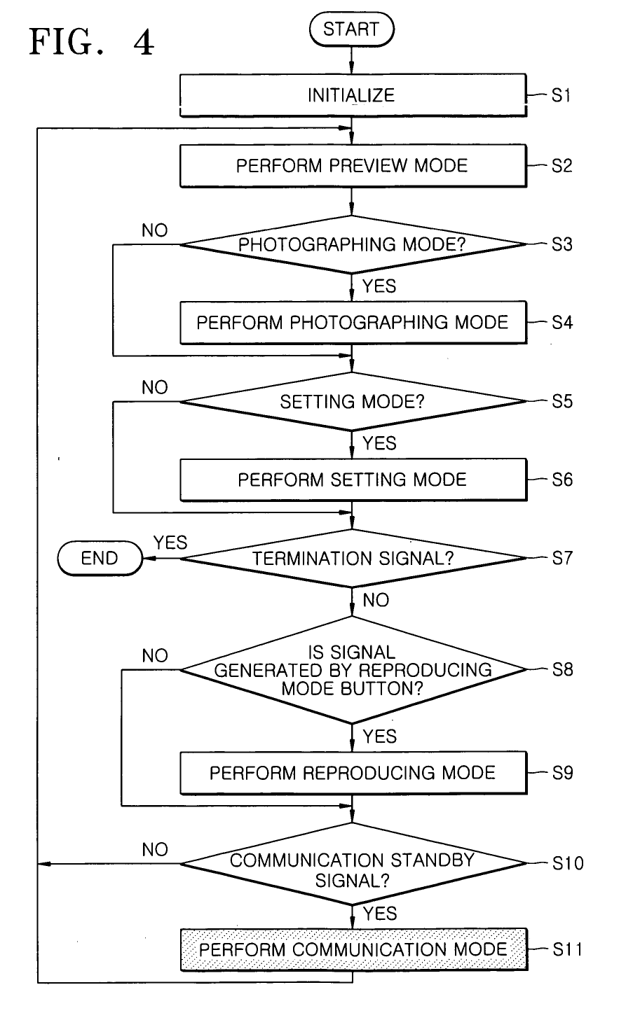

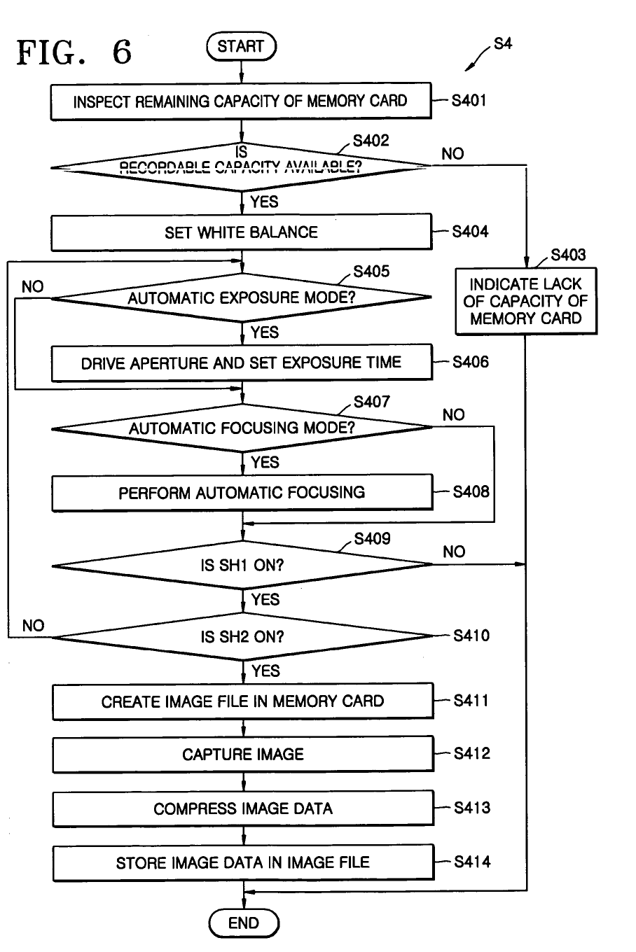

The shutter release button 13 has two levels. In other words, referring to FIGS. 4 and 6, when a user lightly depresses the shutter release button 13 to a first level, a first level signal SH1 from the shutter release button 13 is turned on. When the user fully depresses the shutter release button 13 to a second level, a second level signal SH2 from the shutter release button 13 is turned on.

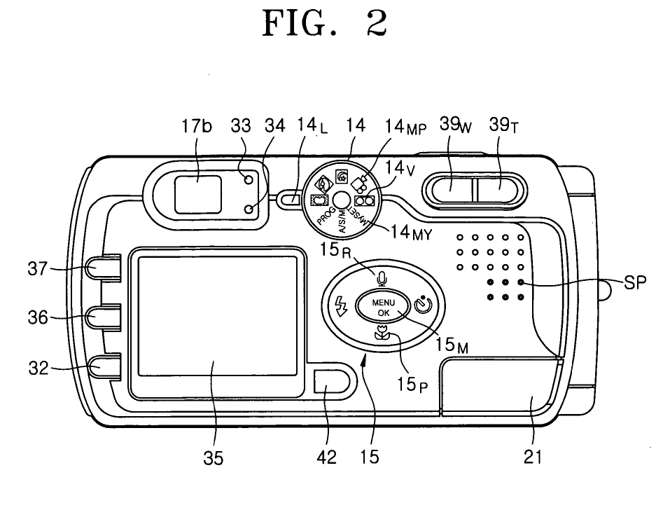

Referring to FIG. 2, the back of the digital camera 1 according to the present invention includes a mode dial 14, functional buttons 15, a manual focus/delete button 36, a manual adjust/reproduce/terminate button 37, a reproducing mode button 42, a speaker SP, a monitor button 32, an automatic focusing lamp 33, a viewfinder 17b, a flash standby lamp 34, a color LCD panel 35, a wide-angle zoom button 39_{W}, a telephoto zoom button 39_{T}, and an external interface unit 21.

The mode dial 14 is used for selecting the operating modes of the digital camera 1. For example, a user may select modes such as a simple photographing mode, a program photographing mode, a character photographing mode, a night-view photographing mode, a manual photographing mode, a moving-image photographing mode, a user-setting mode 14_{MY}, and an audio recording mode 14_{V}.

The user-setting mode 14_{MY} is an operating mode wherein a user selects photograph-taking settings for each photographing mode. Reference numeral 14_{MP} indicates the moving-image photographing mode. The audio recording mode 14_{V} is for recording only sounds, for example, a user's voice. After selecting the audio recording mode 14_{V}, when a user presses the shutter release button 13, an audio file is created in the memory card and audio data is stored in the audio file. When the user presses the shutter release button 13 again, the audio data stops being stored and the audio file is set.

The wide-angle zoom button 39_{W} and the telephoto zoom button 39_{T} are used not only in the photographing mode but also in the reproducing mode. For example, when an image of a standard size is displayed in the reproducing mode, if the telephoto-zoom button 39_{T} is pressed, the image is enlarged and then displayed. If the wide-angle zoom button 39_{W} is pressed when an image of a standard size is displayed in the reproducing mode, an index-reproducing mode is performed. In the index-reproducing mode, a set number of index images are displayed in divided display regions in the sequence in which the index images are set. In the index-reproducing mode, when the telephoto-zoom button 39_{T} is pressed, a general display mode, in which an image currently activated is displayed in a standard size, is performed.

The functional buttons 15 are used for operating specific functions of the digital camera 1, and the functional buttons 15 are also used as control buttons to manage the movement of an active cursor on the menu screen of the color LCD panel 35.

In a reproducing mode, when an image is displayed in the standard size, if the user presses a self-timer/right button 15_{R}, a next file in a forward direction is displayed. When an image currently displayed is enlarged in the reproducing mode, if the user presses the self-timer/right button 15_{R}, a display region of the enlarged image is moved to the right. In a preview mode, if the user presses the self-timer/right button 15_{R}, a self-timer operation, e.g., automatic photographing after 10 seconds, is performed.

In the reproducing mode, when an image is displayed in the standard size, if the user presses a flash/left button 15_{L}, a next file in a reverse direction is displayed. If the image currently displayed is enlarged, when the user presses the flash/left button 15_{L}, the display region of the enlarged image is moved to the left. In the preview mode, if the user presses the flash/left button 15_{L}, any one of the flash modes for a photographing mode is set.

In the reproducing mode, when the image currently displayed is enlarged, if the user presses a macro/down button 15_{D}, the display region of the enlarged image is moved down. In the preview mode, the user may set automatic proximity focusing by pressing the macro/down button 15_{D}.

In the reproducing mode, when the image currently displayed is enlarged, if the user presses a voice-memo/up button 15_{U}, the display region of the enlarged image is moved up. In the preview mode, if the user presses the voice-memo/up button 15_{U}, a 10 second recording is possible upon consecutive photographing.

In a setting mode from the preview mode, if the user presses a menu/select-confirm button 15_{M} when the active cursor is on a selection menu, an operation condition corresponding to the selection menu is set.

The manual adjust/reproduce/terminate button 37 is used for manual adjustment of specific conditions. In the reproducing mode, when the user presses the manual adjust/reproduce/terminate button 37, a selected moving-image file may be reproduced or its reproduction may be terminated.

The manual focus/delete button 36 is used for manual focusing or deleting in the photographing mode.

The monitor button 32 is used for controlling the operation of the color LCD panel 35. For example, in the photographing mode, when the user presses the monitor button 32, an image and photographing information are displayed on the color LCD panel 35. When the user presses the monitor button 32 again, the color LCD panel 35 is turned off. In the reproducing mode, when the user presses the monitor button 32 while an image file is being reproduced, photographing information about the image file is displayed on the color LCD panel 35. When the user presses the monitor button 32 again, only images are displayed.

The reproducing mode button 42 is used for switching between the reproducing mode and the preview mode.

The automatic focusing lamp 33 operates when a focus is well adjusted. The flash standby lamp 34 operates when the flash 12 of FIG. 1 is in a standby mode. A mode indicating lamp 14_{L} indicates a selection mode of the mode dial 14.

FIG. 3 is a schematic diagram of the configuration of the digital camera 1 of FIG. 1. The configuration and operation of the digital camera 1 of FIG. 1 will now be described with reference to FIGS. 1 through 3.

An optical system (OPS) including the lens unit 20 and a filter unit optically processes light from a subject. The lens unit 20 of the OPS includes a zoom lens, a focal lens, and a compensation lens.

When the user presses the wide-angle zoom button 39w or the telephoto zoom button 39_{T} included in a user input portion (INP), a signal corresponding to the wide-angle zoom button 39_{W} or the telephoto zoom button 39_{T} is relayed to the micro-controller 512. The micro-controller 512 controls a driver 510, thereby running a zoom motor M_{Z}, which in turn, moves the zoom lens. In other words, when the user presses the wide-angle zoom button 39_{W}, the focus length of the zoom lens becomes short, thereby widening the angle of view. When the user presses the telephoto zoom button 39_{T}, the focus length of the zoom lens becomes long, thereby narrowing the angle of view. Since the position of the focus lens is adjusted in a state where the position of the zoom lens is set, the angle of view is hardly affected by the position of the focus lens.

In the automatic focusing mode, a main controller built into the DSP 507 controls the driver 510 through the micro-controller 512, thereby driving a focus motor M_{F}. Accordingly, when the focus lens is moved, the position of the focus lens, for example, a number of driving steps of the focus motor M_{F}, having a largest high frequency component of an image signal is set.

The compensation lens in the lens unit 20 of the OPS is not separately operated because the compensation lens compensates for the entire refractive index. Reference numeral M_{A} indicates a motor for driving an aperture (not shown).

An optical low pass filter included in the filter unit of the OPS eliminates high frequency optical noise. An infrared cut filter included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real-time clock (RTC) 503 provides time information to the DSP 507. The DSP 507 processes the digital signal from the CDS-ADC 501 and generates a digital image composed of luminance and chromaticity values.

A light-emitting source (LAMP) is operated by the micro-controller 512 in response to a control signal generated by the DSP 507 including the main controller. The light-emitting source (LAMP) includes the self-timer lamp 11, the automatic focusing lamp 33, the mode indicating lamp 14_{L}, and the flash standby lamp 34. The user input portion INP includes the shutter release button 13, the mode dial 14, the functional buttons 15, the monitor button 32, the manual focus/delete button 36, the manual adjust/reproduce/terminate button 37, the wide-angle zoom button 39_{W}, the telephoto zoom button 39_{T}, and the reproducing mode button 42.

A dynamic random-access memory (DRAM) 504 temporarily stores a digital image signal from the DSP 507. An electrically erasable and programmable read-only memory (EEPROM) 505 stores programs and setting data. A user's memory card is inserted into or removed from a memory card interface 506. The digital image signal from the DSP 507 is input to an LCD driver 514, thereby displaying an image on the color LCD panel 35.

The digital image signal from the DSP 507 can be transmitted as serial communications via a universal serial bus (USB) connector 21a or via an RS232C interface 508 and an RS232C connector 21b. The digital image signal from the DSP 507 can also be transmitted as a video signal via a video filter 509 and a video output unit 21c.

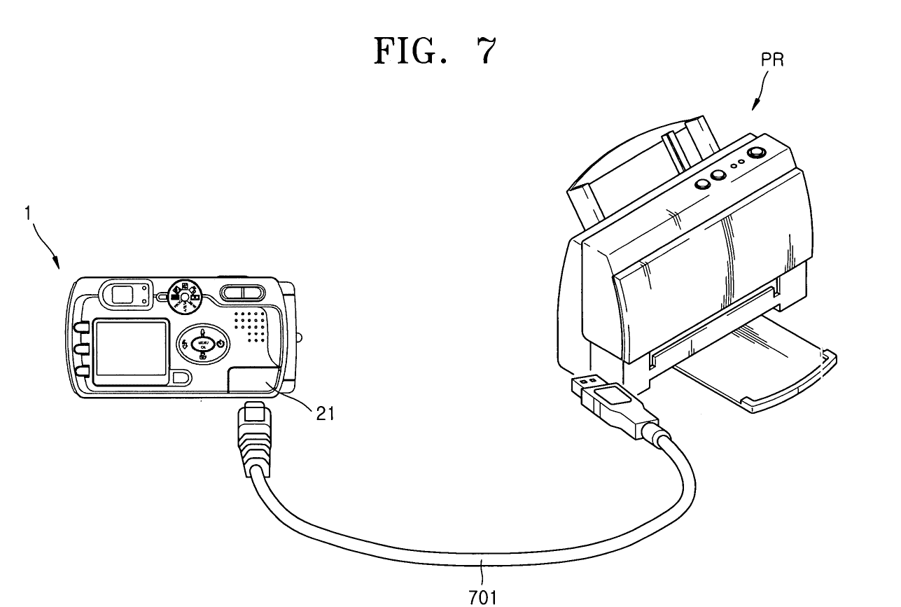

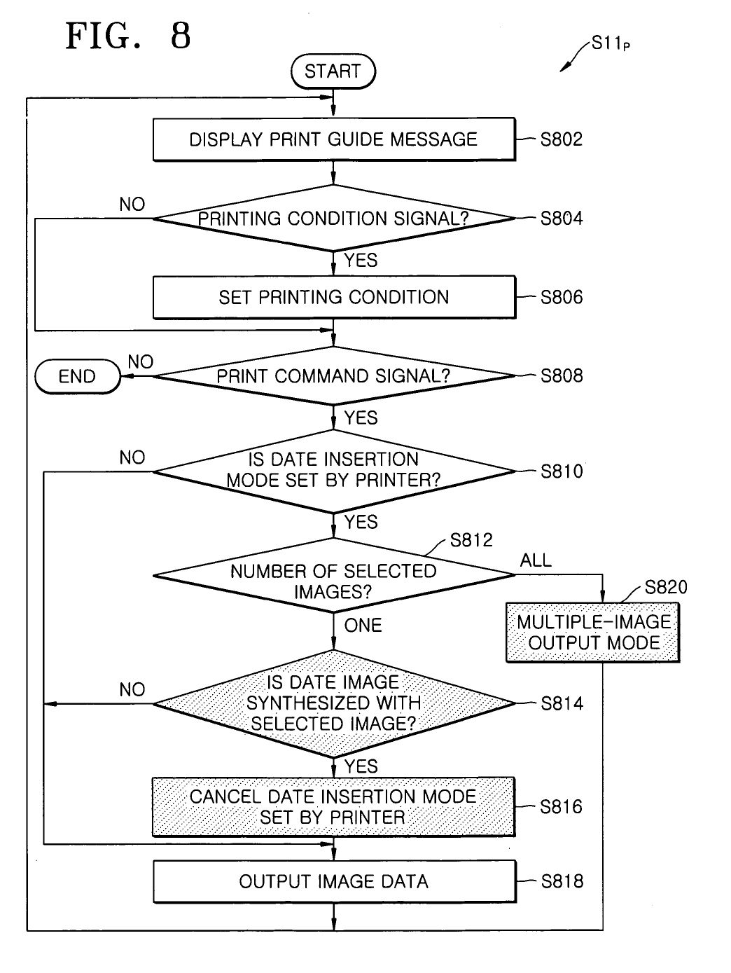

For example, the DSP 507 can control an operation of a printer while communicating with the printer via the USB connector 21a (see FIG. 7). This printing mode program will be described in detail later with reference to FIGS. 8 through 14.

An audio processor 513 can relay sound from the microphone MIC to the DSP 507 or to speaker SP. In addition, the audio processor 513 can output an audio signal from the DSP 507 to the speaker SP.

The micro-controller 512 controls the operation of a flash controller 511 in response to a signal from the flash-luminance sensor 19, thereby driving the flash 12.

A main program of the DSP 507 of FIG. 3 will be now described with reference to FIGS. 1 through 4.

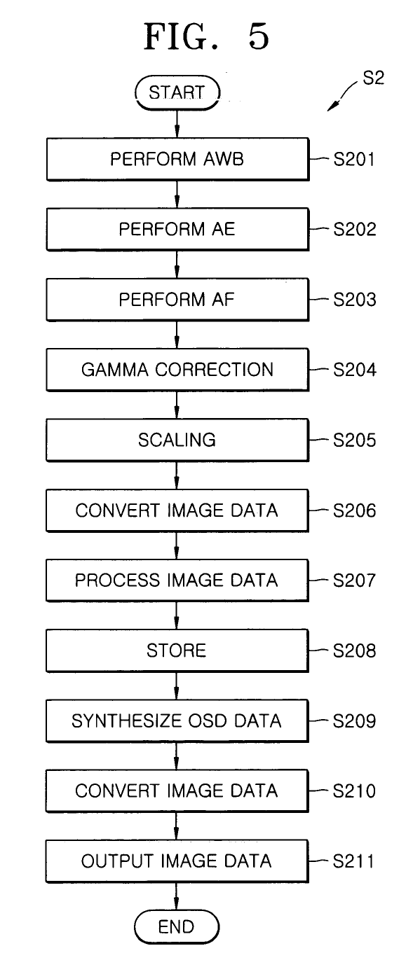

When power is applied to the digital camera 1, the DSP 507 is initialized (S1). After the initialization (S1), the DSP 507 performs a preview mode (S2). In the preview mode, an input image is displayed on the color LCD panel 35. An operation related to the preview mode will be described in detail later with reference to FIG. 5.

When the user lightly depresses the shutter release button 13 to the first level and the first level signal SH1 from the shutter release button 13 is turned on (S3), the DSP 507 performs a current photographing mode (S4). An embodiment of the photographing mode (S4) program will be described in detail with reference to FIG. 6.

When INP-generated signals corresponding to a setting mode are input (S5), the setting mode for setting an operating condition in response to the input signals from the INP is performed (S6). When a termination signal is not generated, the DSP 507 continues to perform the following operations (S7).

When a signal is generated by the reproducing mode button 42 in the user input portion INP (S8), the DSP 507 performs the reproducing mode (S9). In the reproducing mode, the DSP 507 performs a reproduction operation in response to the input signals from the user input portion INP.

When a communication standby signal is input from an external source via the USB connector 21a or the RS232C interface 508 and the RS232C connector 21b (S10), the DSP performs a communication mode corresponding to the communication standby signal (S11). For example, the DSP 507 controls the operation of the printer while USB-communicating with the printer (see FIG. 7). An embodiment of such a printing mode program will be described in detail later with reference to FIGS. 8 through 14. When the communication mode is terminated, the above operations are repeated.

The preview mode (S2) program of FIG. 4 will now be described with reference to FIGS. 1 through 3 and FIG. 5.

The DSP 507 performs automatic white balancing (AWB) and sets parameters related to the white balance (S201). The DSP 507 performs automatic exposure (S202). The DSP 507 calculates the exposure by measuring incident luminance, drives the aperture driving motor MA according to the calculated exposure, and sets exposure time. Then, the DSP 507 performs automatic focusing (S203).

The DSP 507 performs gamma correction on input image data (S204) and scales the gamma-corrected image data to meet display standards (S205). The DSP 507 converts the scaled input image data from an RGB (red, green, and blue) format into a luminance-chromaticity format (S206). The DSP 507 processes the input image data depending on resolution and where the input image data is displayed and filters the input image data (S207).

The DSP 507 temporarily stores the input image data in the DRAM 504 of FIG. 3 (S208). The DSP 507 synthesizes the data temporarily stored in the DRAM 504 of FIG. 3 and on-screen display (OSD) data (S209). The DSP 507 converts the synthesized image data from the RGB format into the luminance-chromaticity format (S210) and outputs the image data in the converted format via the LCD driver 514 of FIG. 3 (S211).

FIG. 6 is a flowchart illustrating an embodiment of the photographing mode (S4) program of FIG. 4. The photographing mode (S4) program of FIG. 4 will now be described with reference to FIGS. 1 through 3 and 6. Here, the current position of the zoom lens is already set.

The DSP 507 inspects the remaining capacity of the memory card (S401) and determines whether the memory card has enough capacity to store a digital image signal (S402). If the memory card does not have enough storage capacity, the DSP 507 indicates the lack of capacity of the memory card and ends the photographing mode (S403). If the memory card has enough storage capacity, the following operations are performed.

The DSP 507 sets white balance and parameters related to the white balance according to a present photographing condition (S404). In the automatic exposure mode (S405), the DSP 507 calculates the exposure by measuring incident luminance, drives the aperture driving motor M_{A} according to the calculated exposure, and sets exposure time (S406). In the automatic focusing mode (S407), the DSP 507 performs automatic focusing and drives the focal lens (S408).

When the first level signal SH1 from the shutter release button 13 is on (S409), the DSP 507 performs the following operations.

The DSP 507 identifies whether the second level signal SH2 is on (S410). When the second level signal SH2 is not on, it means that the user did not press the shutter release button 13 to the second level to take a photograph. Then, the DSP 507 repeats S405 through S410.

When the second level signal SH2 is on, it means that the user fully depressed the shutter release button 13 to the second level. Then, the DSP 507 creates an image file in the memory card (S411). Next, the DSP 507 captures an image (S412). In other words, the DSP 507 receives still-image data from the CDS-ADC 501. Then, the DSP 507 compresses the received still-image data (S413). The DSP 507 stores the compressed still-image data in the image file (S414).

FIG. 7 shows the digital camera 1 connected to a printer PR via a USB cable 701 to illustrate an example of generating the communication standby signal in operation S10 of FIG. 4. More specifically, the USB connector 21a of FIG. 3 included in the external interface unit 21 of the digital camera 1 is connected to a USB connector (not shown) of the printer PR via the USB cable 701.

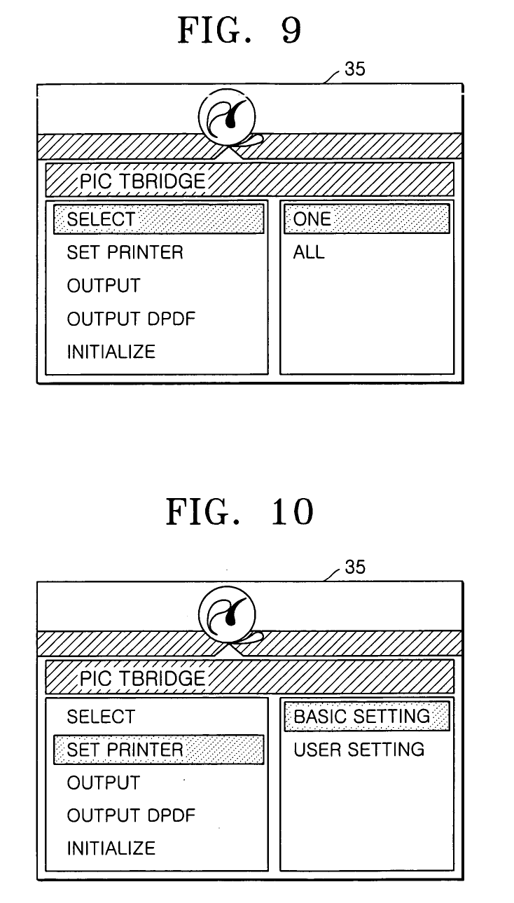

FIG. 8 is a flowchart illustrating a printing mode (S11_{P}) program performed in a connection condition of FIG. 7 as an example of the communication mode (S11) of FIG. 4. FIGS. 9 through 12 show screens displayed on the color LCD panel 35 as a result of performing operations S802 through S806 of FIG. 8. The printing mode (S11_{P}) program of FIG. 8 will now be described with reference to FIGS. 3, 7, 8, and 9 through 12.

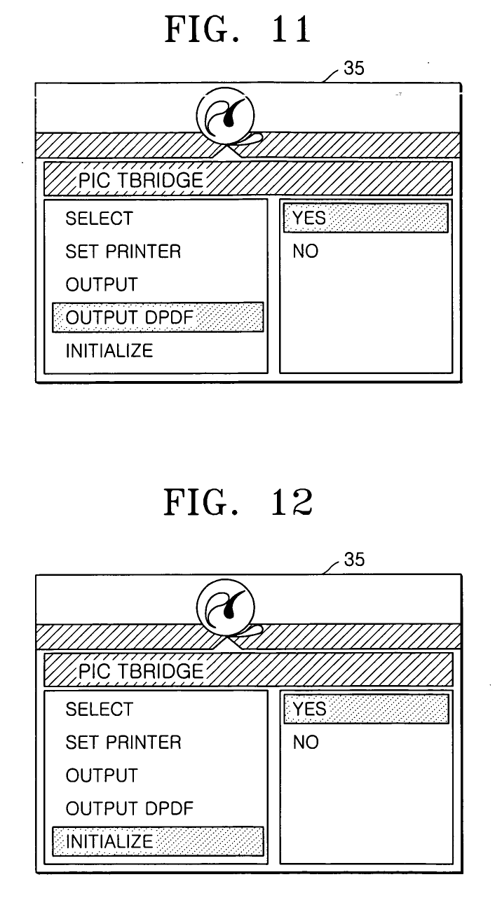

The DSP 507 controls the LCD driver 514 to display a print guide message on the color LCD panel 35 (S802). The DSP 507 sets a printing condition according to a printing condition signal generated by the user input portion INP (S804 and S806). More specifically, the DSP 507 sets a printing condition such as a number of sheets of paper to be printed (see FIG. 9), an operating condition of the printer PR (see FIG. 10), whether to use a digital print order format (DPOF) (see FIG. 11), and whether to initialize the printing condition (see FIG. 12).

For reference, the operating condition of the printer includes a paper size, the number of images per sheet of paper, paper quality, printing resolution, whether to insert a date, and whether to insert a file name. To print the DPOF is to perform a printing operation according to a printing condition stored in the user's memory card.

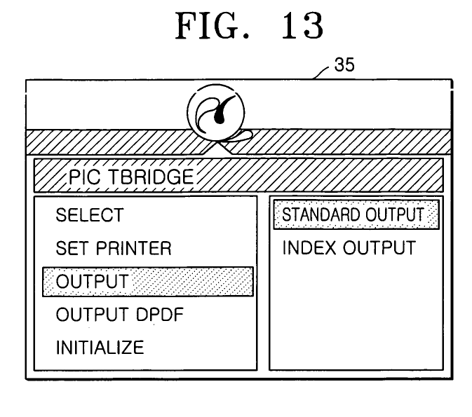

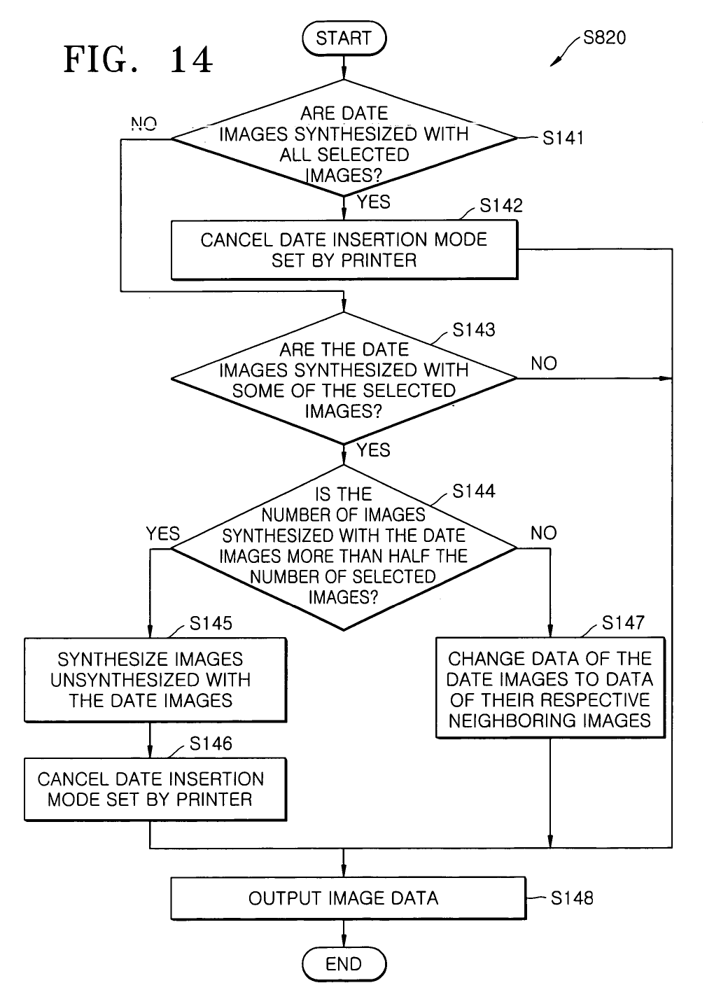

The DSP 507 determines whether a print command signal was input from the user input portion INP (S808). Referring to FIG. 13, when the user selects “Standard Printing” or “Index Printing” and presses the menu/select-confirm button 15_{M} of FIG. 2, the print command signal is generated. If the print command signal is not received, the DSP 507 terminates the printing mode (S11_{P}). If the print command signal is received, the DSP 507 continues to perform the following operations.

The DSP 507 determines whether a date insertion mode is set by the printer PR (S810). If the date insertion mode is not set by the printer PR, the DSP 507 outputs data of selected images to the USB connector 21a and repeats operation S802 and its subsequent operations (S810 and S818).

If the date insertion mode is set by the printer PR in operation S810, the following operations are performed. The DSP 507 identifies the number of images selected to print in the setting condition (S812).

If the number of selected images is one (see FIG. 9), the DSP 507 determines whether a date image is synthesized with the selected image (S814). If the date image is not synthesized with the selected image, the DSP 507 outputs data of the selected image to the USB connector 21a and repeats operation S802 and its subsequent operations (S814 and S818). If the date image is synthesized with the selected image, the DSP 507 cancels the date insertion mode set by the printer PR to prevent double insertion (S816). In addition, the DSP 507 outputs data of the selected image to the USB connector 21a and repeats operation S802 and its subsequent operations (S818).

If the number of selected images is more than one, for example, if all images are selected (see FIG. 9), the DSP 507 performs a multiple-image output mode (S820). The multiple-image output mode (S820) program of FIG. 8 will now be described with reference to FIGS. 3, 7, and 14.

The DSP 507 determines whether date images are synthesized with the selected images (S141). If the date images are synthesized with the selected images, the DSP 507 cancels the date insertion mode set by the printer PR to prevent double insertion (S142). In addition, the DSP 507 outputs data of the selected images to the USB connector 21a and terminates the multiple-image output mode (S148).

If the date images are not synthesized with the selected images, the DSP 507 performs the following operations. If the date images are synthesized with some of the selected images, the DSP 507 determines whether the number of images synthesized with the date images is more than half the number of selected images (S144).

If the number of images synthesized with the date images is more than half the number of selected images, the DSP 507 synthesizes the date images with unsynthesized images (S145) and cancels the date insertion mode set by the printer PR (S146). Thus, the double insertion of dates can be prevented. Then, the DSP 507 outputs data of the selected images to the USB connector 21a and terminates the multiple-image output mode (S148).

If the number of images synthesized with the date images is not more than half the number of selected images, the DSP 507 changes data of synthesized date images to become data of respective neighboring images (S144 and S147). Therefore, the date images synthesized with the respective selected images are effectively deleted, thereby effectively preventing the double insertion of dates. Then, the DSP 507 outputs data of the selected images to the USB connector 21 a and terminates the multiple-image output mode (S148).

As described above, according to a method of controlling a digital image processing apparatus and a digital image processing apparatus adopting the method, a printer does not insert a date into an image synthesized with a date image by a printer. Since a date is not inserted again into a printed image, the quality of the printed image can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a digital image processing apparatus, the method comprising:
determining whether a selected image is synthesized with a date image;
determining whether an output device is in a date insertion mode; and
if the selected image is synthesized with the date image and the output device is in the date insertion mode, canceling the date insertion mode on the output device.

2. The method of claim 1, wherein the output device is a printer.

3. The method of claim 1, wherein the digital image processing apparatus is a digital camera.

4. The method of claim 1, further comprising outputting data representing the selected image to the output device.

5. The method of claim 1, wherein the steps of claim 1 are performed in response to detecting an output command signal.

6. The method of claim 1, wherein:
the selected image is one of a plurality of selected images; and
the date insertion mode on the output device is canceled if each member of the plurality of selected images has been synthesized with a corresponding date image.

7. The method of claim 1, further comprising:
determining whether a plurality of images is selected;
determining how many of the selected images are synthesized with corresponding date images; and
if a majority of the selected images are synthesized with corresponding date images, synthesizing the rest of the selected images with corresponding date images and canceling the date insertion mode set by the output device.

8. The method of claim 1, further comprising:
determining whether a plurality of images is selected;
determining how many of the selected images are synthesized with corresponding date images; and
if a majority of the selected images are not synthesized with corresponding date images, ceasing to display the date images with those selected images that are synthesized with corresponding date images.

9. A method of controlling a digital photographing apparatus that is communicatively linked to a printer, the method comprising:
receiving a user selection of an image;
determining whether the selected image includes a date image;
determining whether the printer is in a date insertion mode; and
if the selected image includes the date image and the printer is in the date insertion mode, taking the printer out of the date insertion mode.

10. The method of claim 9, further comprising the printer printing the selected image.

11. The method of claim 9, further comprising displaying a print guide message.

12. The method of claim 9, wherein the selected image is a member of a plurality of selected images.

13. The method of claim 12, further comprising taking the printer out of the date insertion mode if all of the plurality of selected images include a corresponding date image.

14. The method of claim 12, further comprising:
determining whether a majority of the plurality of selected images include corresponding date images; and
if the majority of the plurality of selected images include corresponding date images, synthesizing corresponding date images with the remainder of the selected images and taking the printer out of the date insertion mode.

15. The method of claim 12, further comprising:
determining whether less than a majority of the plurality of selected images include corresponding date images; and
if less than a majority of the plurality of selected images include corresponding date images, ceasing to display the date images with those selected images that are synthesized with corresponding date images.

16. A digital image processing apparatus that controls an operation of an output device while communicating with the output device, wherein the apparatus comprises a digital processor that performs steps comprising:
controlling the digital image processing apparatus to determine whether the output device has set a date insertion mode;
determining whether a date image is synthesized with an image to be output; and
canceling the date insertion mode of the output device if the output device is in the date insertion mode and the image to be output has been synthesized with the date image.

17. The apparatus of claim 16, further comprising:
a lens unit that receives light from a subject to be photographed by the apparatus;
a photoelectric device that converts the received light to analog electrical signals;
an analog-to-digital conversion unit that receives the analog electrical signals and converts them to digital signals, wherein the digital processor receives and processes the digital signals, thereby generating a signal which represents an image of the subject; and
a storage medium for storing a file containing the image.

18. The apparatus of claim 16, further comprising a user input portion and a display screen.

19. The apparatus of claim 17, wherein the digital processor further controls the apparatus to display a print guide message and to detect a printing condition signal.

20. The apparatus of claim 16, wherein the digital processor further controls the apparatus to determine whether a plurality of images has been selected and, if so, which members of the plurality of selected images have been synthesized with corresponding date images.
